(19) United States
(12) Patent Application Publication
(10) Pub. No.: US 2023/0257011 A1
(43) Pub. Date: Aug. 17, 2023

(54) SYSTEM AND METHOD FOR AUTOMATICALLY ADJUSTING PLANNED TRAIN OPERATION DIAGRAM

(71) Applicant: CASCO SIGNAL LTD., Shanghai (CN)

(72) Inventors: Fengbo LIU, Shanghai (CN); Jiang QIAN, Shanghai (CN); Tingliang ZHOU, Shanghai (CN); Xiang WU, Shanghai (CN); Jing XU, Shanghai (CN); Junkui QIU, Shanghai (CN); Gongjian ZHOU, Shanghai (CN); Xiao LIU, Shanghai (CN)

(73) Assignee: CASCO SIGNAL LTD., Shanghai (CN)

(21) Appl. No.: 18/013,254

(22) PCT Filed: Sep. 28, 2021
(86) PCT No.: PCT/CN2021/121145

§ 371 Date: Dec. 28, 2022

(30) Foreign Application Priority Data
Feb. 18, 2021 (CN) 202110188356.2

(51) Int. Cl. B61L 27/16; B61L 27/04

(52) U.S. Cl. CPC B61L 27/16; B61L 27/04

(57) ABSTRACT

The present disclosure relates to a system and method for automatic adjustment of a planned train operation chart. The system comprises a train operation data analysis module, a passenger flow data matching module, and an operation chart adjustment module that are connected in sequence. The train operation data analysis module is connected to the operation chart adjustment module; the train operation data analysis module assesses the deviation between an actual operation chart and a planned operation chart on the basis of ATS historical operation data to obtain an operation chart assessment result; the passenger flow data matching module calculates the actual passenger flow distribution on the basis of on-board weighing passenger flow data and AFC passenger flow data, and matches the actual passenger flow distribution with the actual operation chart to obtain a passenger flow matching result; and the operation chart adjustment module performs optimizing adjustment.

### TECHNICAL FIELD

The invention relates to train signal control systems, in particular to a system and method for automatically adjusting a planned train operation diagram which integrate train operation data and passenger flow data.

### BACKGROUND

In current rail transit operation management, a diagram maker makes necessary adjustments to an operation diagram based on irregular passenger flow demand analysis and investigation, mainly by increasing the number of trains put into operation and shortening the train interval, so as to improve transportation capacity. To conduct passenger flow demand analysis and investigation, a lot of manpower and material resources are often required for on-site investigation, cross-functional coordination is necessary, and the decision-making cycle is long, all of which lead to high operation management cost and long demand response lag. Besides, operation parameters are rarely changed after being determined before a line is open, but they may not conform to planned values in the actual operation practice, which will directly affect the quality evaluation of the operation diagram and operation performance.

It is found through searching that in Chinese patent No. CN108090668A titled “Time-Varying Passenger Flow-Driven Urban Rail Transit Passenger Flow Matching and Timetable Adjustment Method”, allocated time-varying line passenger flow OD data based on minutes are matched with a current train operation diagram, congestion intervals and idle intervals are figured out through analysis based on the matching state, and then operation diagram compilation parameters are modified, so as to adjust and update the train operation diagram. When matching passenger flow with the operation diagram, the invention uses a planned operation diagram instead of an actual operation diagram, which will make matching results far different from the reality. It should be actual operation data generated after the execution of the planned diagram that are to be matched with historical passenger flow data, which is not considered in this invention.

It is found through searching that in the article “Method for Checking and Correcting Operation Diagram Parameters Based on Monitoring Data Mining [J]. China Railway Science, 032(4):117-121” by Wang Jun et al., an abnormal data processing method based on statistics is used to process train operation data which are actually measured, and by analyzing the concentration trend, dispersion degree and distribution pattern of the actually measured data and conducting time interval grouping on the data according to train types, a fitting curve regression model which can reasonably reflect the data change trend is established for parameter correction, and a parameter correction system is formed. However, this article did not consider the actual passenger flow demand, nor did it discuss how to use obtained results to adjust a planned operation diagram.

### SUMMARY

In order to overcome the defects of the prior art, the invention provides a system and method for automatically adjusting a planned train operation diagram which integrate train operation data and passenger flow data. The system and method are close to reality and improve diagram adjustment efficiency.

The purpose of the invention can be realized by the following technical scheme.

According to one aspect of the invention, a system for automatically adjusting a planned train operation diagram is provided, which comprises a train operation data analysis module, a passenger flow data matching module and an operation diagram adjustment module which are connected in sequence, wherein the train operation data analysis module is connected with the operation diagram adjustment module;

the train operation data analysis module evaluates the difference between an actual operation diagram and the planned operation diagram based on ATS historical operation data to obtain an operation diagram evaluation result;

the passenger flow data matching module calculates actual passenger flow distribution based on vehicle weighing passenger flow data and AFC passenger flow data, and matches the same with the actual operation diagram to obtain a passenger flow matching result; and

the operation diagram adjustment module optimizes and adjusts the original planned operation diagram according to the operation diagram evaluation result and the passenger flow matching result combined with the driving conditions of a line and the constraints of transportation resources.

As a preferred technical scheme, the train operation data analysis module comprises a train operation data interface, a train operation data preprocessing unit and a train operation parameter checking unit.

As a preferred technical scheme, the passenger flow data matching module comprises a passenger flow data interface, a passenger flow data analysis unit and a transportation capacity and traffic volume matching unit.

As a preferred technical scheme, the operation diagram adjustment module comprises a starting scheme adjustment module and an operation parameter adjustment module.

As a preferred technical scheme, the starting scheme adjustment module comprises a routing scheme adjustment unit, an interval scheme adjustment unit and a vehicle bottom use scheme adjustment unit.

As a preferred technical scheme, the operation parameter adjustment module comprises a stop time adjustment unit, a section operation time adjustment unit and a turn-back time adjustment unit.

As a preferred technical scheme, the data of the operation data analysis module and the passenger flow matching module are stored in a unified database server, which can store and quickly read and write a large number of multi-source heterogeneous data.

According to another aspect of the invention, an adjustment method adopting the system for automatically adjusting a planned train operation diagram is provided, which comprises the following steps:

1. preprocessing and analyzing train operation data recorded by an automatic train supervision system (ATS), and evaluating the difference between planned values and actual values of operation parameters to obtain an operation data evaluation result;

2. conducting passenger flow analysis based on vehicle weighing data and automatic fare collection (AFC) data, and conducting transportation capacity and traffic volume matching in combination with actual train operation data in step 1 to obtain a transportation capacity and traffic volume matching result;

3. determining whether the operation parameters of stop time, section operation time and turn-back time need to be adjusted based on the operation data evaluation result in step 1, and determining an adjustment scheme in combination with the constraints of actual line driving conditions if yes;

4. determining whether a routing scheme, an interval scheme and a vehicle bottom use scheme need to be adjusted based on the transportation capacity and traffic volume matching result in step 2, and determining an adjustment scheme in combination with actual line transportation capacity resource allocation if yes; and

5. adjusting and optimizing the planned operation diagram based on the adjustment of the operation parameters and the adjustment of a starting scheme in steps 3 and 4.

As a preferred technical scheme, adjustment and determination in step 3 specifically comprise:

setting an adjustment threshold for each operation parameter, adjusting a planned operation parameter if the difference between a reference process time in the operation data evaluation result obtained in step 1 and the planned operation parameter exceeds the threshold, and otherwise, conducting no adjustment.

As a preferred technical scheme, adjustment and determination in step 4 specifically comprise:

setting an adjustment threshold for a section full load rate, adjusting the starting scheme if a full load rate in the transportation capacity and traffic volume matching result obtained in step 2 exceeds the threshold, and otherwise, conducting no adjustment.

Compared with the prior art, the invention has the following advantages.

1. Extracting transportation capacity data based on the actual train operation data can effectively improve the accuracy of transportation capacity and traffic volume matching. Besides, checking the parameters of the planned operation diagram by referring to a large number of historical operation data can effectively evaluate the rationality of the planned parameters.

2. Compared with previous manual planned operation diagram adjustment, the planned operation diagram adjustment system integrates the train operation data and passenger flow data and automatically processes the data, and a given adjustment scheme is directly applied to the operation diagram, which improves diagram adjustment efficiency.

### BRIEF DESCRIPTION OF THE DRAWINGS

FIG. 1 is a principle block diagram of a system for automatically adjusting a planned operation diagram of the invention.

FIG. 2 is a functional module block diagram of a system for automatically adjusting a planned operation diagram of the invention.

FIG. 3 is a flowchart of a method for automatically adjusting a planned operation diagram of the invention.

### DETAILED DESCRIPTION OF THE EMBODIMENTS

Hereinafter, the technical scheme in the embodiments of the invention will be described clearly and completely with reference to the drawings in the embodiments of the invention. Obviously, the described embodiments are only part of the embodiments of the invention, not all of the embodiments. Based on the embodiments of the invention, all other embodiments obtained by those of ordinary skill in the art without creative labor are within the scope of the invention.

### Embodiment 1

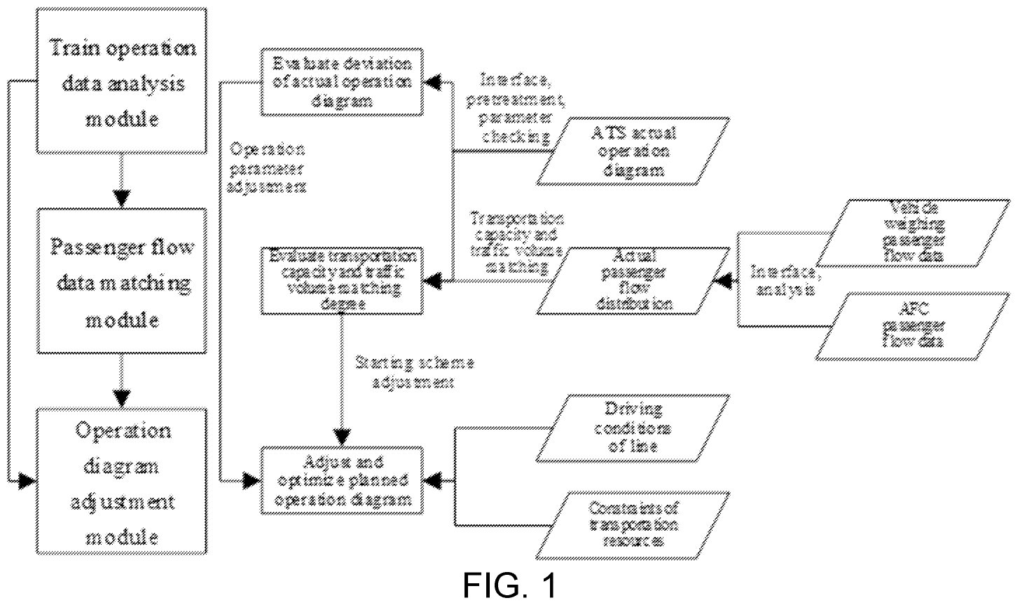

As shown in FIG. 1, Embodiment 1 of the invention provides a system for adjusting a planned operation diagram which integrates train operation data and passenger flow data. The system mainly consists of a train operation data analysis module, a passenger flow data matching module and an operation diagram adjustment module;

the train operation data analysis module evaluates the difference between an actual operation diagram and the planned operation diagram based on ATS historical operation data;

the passenger flow data matching module calculates actual passenger flow distribution based on vehicle weighing passenger flow data and AFC passenger flow data and matches the same with the actual operation diagram; and

the operation diagram adjustment module optimizes and adjusts the original planned operation diagram according to the operation diagram evaluation result and the passenger flow matching result combined with the driving conditions of a line and the constraints of transportation resources.

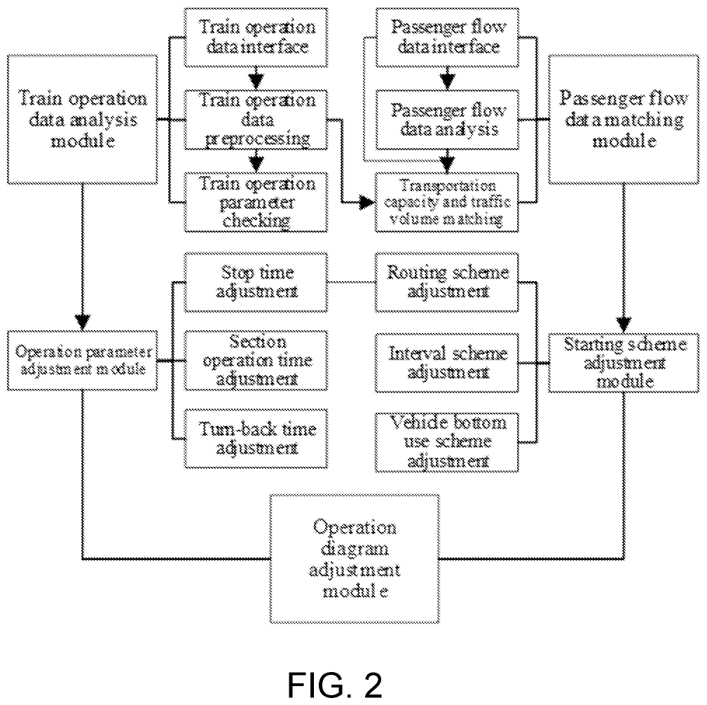

As shown in FIG. 2, the three modules described in Embodiment 1 of the invention are illustrated in details.

The train operation data analysis module comprises a train operation data interface, a train operation data preprocessing unit and a train operation parameter checking unit. The passenger flow data matching module comprises a passenger flow data interface, a passenger flow data analysis unit and a transportation capacity and traffic volume matching unit.

The operation diagram adjustment module comprises a starting scheme adjustment module and an operation parameter adjustment module. The starting scheme adjustment module comprises a routing scheme adjustment unit, an interval scheme adjustment unit and a vehicle bottom use scheme adjustment unit. The operation parameter adjustment module comprises a stop time adjustment unit, a section operation time adjustment unit and a turn-back time adjustment unit.

### Embodiment 2

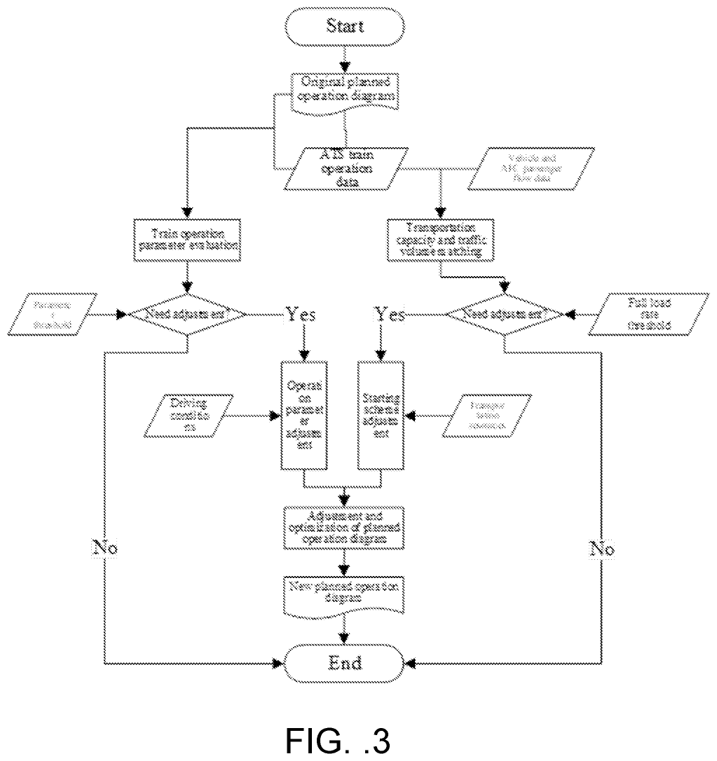

As shown in FIG. 3, Embodiment 2 of the invention provides a method for adjusting a planned operation diagram which integrates train operation data and passenger flow data. The method comprises the following steps:

1. preprocessing and analyzing train operation data recorded by an automatic train supervision system (ATS), and evaluating the difference between planned values and actual values of operation parameters;

wherein actual operation data are acquired through a train operation data interface and stored in a database, including the arrival or departure time of each train at each station track and the difference from planned time, destination, direction and other information; invalid data are filtered out; the cleaned arrival and departure time data are converted into operation process data according to a train travel sequence, mainly including stop time, section operation time and turn-back time; and statistical analysis is conducted on a large number of data in each operation process, and the deviation between planned values and actual values of operation process parameters is calculated, so as to obtain a reference process time, that is, fitting values of actual stop time, section operation time or turn-back time at each position;

2. conducting passenger flow analysis based on vehicle weighing data and AFC data, and conducting transportation capacity and traffic volume matching in combination with actual train operation data in step 1;

wherein vehicle weighing data and AFC inbound and outbound data are accessed through a passenger flow data interface, the vehicle weighing data include the total weight of each train when the train leaves a station, and the passenger flow data of each train are obtained by conversion; the AFC inbound and outbound data include the inbound name, outbound name, inbound time and outbound time of each passenger, and passenger flow OD data of all lines can be obtained through a network passenger flow allocation algorithm; through mutual verification and supplement of the two groups of data, complete cross-section passenger flow data are obtained; and the section passenger flow data of the same minute granularity are matched with train passenger capacity data to obtain a section full load rate;

3. determining whether the operation parameters of stop time, section operation time and turn-back time need to be adjusted based on an operation data evaluation result in step 1, and determining an adjustment scheme in combination with the constraints of actual line driving conditions if yes;

wherein an adjustment threshold is set for each operation parameter, a planned operation parameter is adjusted if the difference between a reference process time obtained in step 1 and the planned operation parameter exceeds the threshold, and otherwise, no adjustment is conducted; and the adjustment degree of each parameter also depends on the actual line driving conditions, for example, the constraint of front and rear train spacing must be followed all the time;

4. determining whether a routing scheme, an interval scheme and a vehicle bottom use scheme need to be adjusted based on a transportation capacity and traffic volume matching result in step 2, and determining an adjustment scheme in combination with actual line transportation capacity resource allocation if yes;

wherein an adjustment threshold is set for a section full load rate, the starting scheme is adjusted if a full load rate obtained in step 2 exceeds the threshold, and otherwise, no adjustment is conducted; if it is necessary to adjust the routing and train interval to improve transportation capacity, whether the vehicle resources and signal configuration of the line can meet the demand also needs to be considered; and

5. adjusting and optimizing the planned operation diagram based on the adjustment of the operation parameters and the adjustment of a starting scheme in steps 3 and 4.

wherein a new planned operation diagram is tried on the basis of the planned parameter adjustment scheme in step 3 and the starting scheme adjustment scheme in step 4; under specific vehicle bottom and other transportation resource conditions, a routing scheme and interval scheme closest to the adjustment demand are formulated, including the proportion of single routing or complex routing and the interval between different zones; an initial adjustment value of the planned parameter is set as the reference process time, then whether the front and rear train spacing after adjustment is satisfactory is checked, if not, the adjustment range is reduced until the condition is met, and a new planned operation diagram is finally obtained.

The above are only specific embodiments of the invention, but the protection scope of the invention is not limited thereto. Any person familiar with the technical field can easily think of various equivalent modifications or substitutions within the technical scope disclosed by the invention, and these modifications or substitutions should fall within the protection scope of the invention. Therefore, the protection scope of the invention shall be subject to the protection scope of the claims.

1. A system for automatically adjusting a planned train operation diagram, comprising a train operation data analysis module, a passenger flow data matching module and an operation diagram adjustment module which are connected in sequence, wherein the train operation data analysis module is connected with the operation diagram adjustment module;
the train operation data analysis module evaluates the difference between an actual operation diagram and a planned operation diagram based on an automatic train supervision system (ATS) historical operation data to obtain an operation diagram evaluation result;
the passenger flow data matching module calculates actual passenger flow distribution based on vehicle weighing passenger flow data and an automatic fare collection (AFC) passenger flow data, and matches the same with the actual operation diagram to obtain a passenger flow matching result; and
the operation diagram adjustment module optimizes and adjusts an original planned operation diagram according to the operation diagram evaluation result and the passenger flow matching result combined with driving conditions of a line and constraints of transportation resources.

2. The system for automatically adjusting the planned train operation diagram according to claim 1, wherein the train operation data analysis module comprises a train operation data interface, a train operation data preprocessing unit and a train operation parameter checking unit.

3. The system for automatically adjusting the planned train operation diagram according to claim 1, wherein the passenger flow data matching module comprises a passenger flow data interface, a passenger flow data analysis unit and a transportation capacity and traffic volume matching unit.

4. The system for automatically adjusting the planned train operation diagram according to claim 1, wherein the operation diagram adjustment module comprises a starting scheme adjustment module and an operation parameter adjustment module.

5. The system for automatically adjusting the planned train operation diagram according to claim 4, wherein the starting scheme adjustment module comprises a routing scheme adjustment unit, an interval scheme adjustment unit, and a vehicle bottom use scheme adjustment unit.

6. The system for automatically adjusting the planned train operation diagram according to claim 4, wherein the operation parameter adjustment module comprises a stop time adjustment unit, a section operation time adjustment unit, and a turn-back time adjustment unit.

7. The system for automatically adjusting the planned train operation diagram according to claim 1, wherein data of operation data analysis module and passenger flow matching module are stored in a unified database server, which can store and quickly read and write a large number of multi-source heterogeneous data.

8. An adjustment method adopting the system for automatically adjusting the planned train operation diagram according to claim 1, comprising the following steps:
(1) preprocessing and analyzing train operation data recorded by an automatic train supervision system (ATS), and evaluating the difference between planned values and actual values of operation parameters to obtain an operation data evaluation result;
(2) conducting passenger flow analysis based on vehicle weighing data and automatic fare collection (AFC) data, and conducting transportation capacity and a traffic volume matching in combination with an actual train operation data in the step 1 to obtain a transportation capacity and traffic volume matching result;
(3) determining whether the operation parameters of stop time, section operation time and turn-back time need to be adjusted based on the operation data evaluation result in the step 1, and determining an adjustment scheme in combination with the constraints of actual line driving conditions if yes;
(4) determining whether a routing scheme, an interval scheme and a vehicle bottom use scheme need to be adjusted based on the transportation capacity and traffic volume matching result in the step 2, and determining an adjustment scheme in combination with actual line transportation capacity resource allocation if yes; and
(5) adjusting and optimizing the planned operation diagram based on the adjustment of the operation parameters and the adjustment of a starting scheme in the steps 3 and 4.

9. The method according to claim 8, wherein adjustment and determination in step 3 specifically comprise:
setting an adjustment threshold for each operation parameter, adjusting a planned operation parameter if the difference between a reference process time in the operation data evaluation result obtained in the step 1 and the planned operation parameter exceeds the threshold, and otherwise, conducting no adjustment.

10. The method according to claim 8, wherein adjustment and determination in the step 4 specifically comprise:
setting an adjustment threshold for a section full load rate, adjusting the starting scheme if a full load rate in the transportation capacity and traffic volume matching result obtained in the step 2 exceeds the threshold, and otherwise, conducting no adjustment.
